(19) United States
(12) Patent Application Publication
(10) Pub. No.: US 2007/0156315 A1
(43) Pub. Date: Jul. 5, 2007

(54) Method and device for determining a vehicle state

(75) Inventors: Markus Raab, Kirchhardt (DE); Alexander Stein, Alpenrod (DE)

Correspondence Address: FITCH, EVEN, TABIN & FLANNERY, P. O. BOX 18415, WASHINGTON, DC, 20036, US

(73) Assignee: DAIMLER CHRYSLER AG, STUTTGART (DE)

(21) Appl. No.: 10/583,969

(22) PCT Filed: Dec. 21, 2004
(86) PCT No.: PCT/EP04/14528

§ 371 Date: Nov. 6, 2006

(30) Foreign Application Priority Data
Dec. 23, 2003 (DE) 103 60 728.5

(51) Int. Cl. G05D 1/00

(52) U.S. Cl. 701/38; 701/1

(57) ABSTRACT

The present invention relates to a method for determining a vehicle state having the method steps: estimation of a first state in a vehicle (F) by means of a first vehicle model using predetermined parameters (\dot{Ψ}, \ddot{Ψ}, a_{y}, aₓ); estimation of a second state of the vehicle (F) by means of a second vehicle model using the predetermined parameters (\dot{Ψ}, \ddot{Ψ}, a_{y}, aₓ); weighted switching over from the first vehicle model to the second vehicle model at the transition of the vehicle (F) from the first state into the second state as a function of at least one estimated parameter (φ). The present invention also makes available a device for determining a state of a vehicle (F).

The invention relates to a method and a device for determining a vehicle state, and in particular to a method and a device for determining vehicle states about which knowledge is necessary in order to stabilize a vehicle when a tilting angle is reached.

In modern motor vehicles, the influence of electrical and electronic driving safety systems, for example ESP (Electronic Stability Program) which is intended to prevent a vehicle skidding within fixed physical limits, is always increasing. The aforesaid ESP system controls the yaw rate of the vehicle. Since, for reasons of cost, the intention is to detect critical driving states and movement states of the vehicle with as few sensor means as possible, efforts are made to be able to determine movement variables or movement states using a small number of measured parameters.

DE 41 23 053 discloses a method for determining at least one movement variable of a vehicle. In this context, a transverse velocity and/or a yaw rate of the vehicle, or a movement variable which is dependent thereon, are described with the measurement variables of a transverse acceleration and of a steering angle at both vehicle axles. In order to evaluate the sensed measurement variables, a combination of two adaptive, equivalent Kalman filter pairs is provided, a sum of measurement variables being supplied to one filter pair, and a difference between measurement variables being supplied to the other filter pair.

DE 195 15 055 describes a driving stability control circuit with speed-dependent changeover of the vehicle model, in which circuit a setpoint value of a yaw rate is calculated using a vehicle model. In order to be able to calculate a value which is precise as possible both at very high velocities and at very low velocities using the vehicle model circuit, at least two vehicle models to which suitable velocity ranges are assigned are provided within the vehicle model circuit, switching over occurring between the two models as a function of the velocity range which is currently being used. A hysteresis of the two velocity threshold values at which switching over occurs as well as means for avoiding jumps in the output signal of the vehicle model circuit when the corresponding switching over between the models occurs are described in said document.

However, the two aforesaid known methods and devices are not suitable for determining the transition from a first vehicle state to another vehicle state or movement state of the vehicle, in particular from a rolling movement into a tilting movement, in order to be able to implement corresponding countermeasures, for example by means of a braking intervention for stabilization purposes, in particular in a way which is inherent to this system.

The object on which the present invention is based comprises making available a method and a device for determining a vehicle state, in particular a vehicle movement state, with which a tilting movement of a vehicle can be identified in a way which is reliable and as unambiguous as possible.

This object is achieved according to the invention by means of a method having the features of patent claim 1 and by means of a device for determining a vehicle state having the features of patent claim 12.

Accordingly, the following are provided:
A method for determining a vehicle state having the method steps: estimation of a first state in a vehicle by means of a first vehicle model using predetermined parameters; estimation of a second state of the vehicle by means of a second vehicle model using the predetermined parameters; weighted switching over from the first vehicle model to the second vehicle model at the transition of the vehicle from the first state into the second state as a function of at least one estimated parameter. (Patent claim 1)
A device for determining a vehicle state having: a first estimation device for estimating a first state of a vehicle by means of a first vehicle model using predetermined parameters; a second estimation device for estimating a second state of the vehicle by means of a second vehicle model using the predetermined parameters; a switchover device for the weighted switching over from the first vehicle model to the second vehicle model at the transition of the vehicle from the first state into the second state as a function of at least one estimated parameter. (Patent claim 12).

The idea on which the present invention is based consists essentially in estimating movement states of a vehicle, in particular a rolling angle or tilting angle, over an entire rolling movement or tilting movement, in each case different vehicle models, in particular different Kalman filters, being used for the rolling movement and for the tilting movement. The states which are estimated by the vehicle models are weighted as a function of the rolling or tilting behavior present and superimposed so that the transition from the estimates of the vehicle model which is provided for the rolling movement to the estimates of the vehicle model which is provided for the tilting movement takes place in a fluid fashion. Above all, the intention is to ensure that no jump in the estimated variables occurs. In other words: the rolling angle or the tilting angle is intended to be determined continuously over the movement spectrum of the vehicle under consideration, i.e. starting from a rolling movement and going on into the tilting movement.

The formulation “predetermined parameters” used above is to be understood as follows: these variables are those variables as a function of which the states of the vehicle are determined. These variables constitute, as it were the input variables for the vehicle models or Kalman filters. These variables may be measurement variables or variables derived from measurement variables by simple conversion calculations.

Both the vehicle model provided for the rolling movement and the vehicle model provided for the tilting movement use the same variables in each case for determining the states of the vehicle.

Advantageous refinements and developments of the invention can be found in the subclaims and the description with reference to the drawing.

According to one preferred development, the first vehicle model simulates movement states of the vehicle by means of a first Kalman filter, and the second vehicle model simulates movement states of the vehicle by means of a second Kalman filter.

According to a further preferred development, the first state of the vehicle stands for a rolling movement of the vehicle, and the second state of the vehicle stands for a tilting movement of the vehicle, a rolling movement describing a rotational movement about a vehicle longitudinal axis with ground contact with all the wheels, and a tilting movement corresponding to a rotational movement which follows the rolling movement with loss of the ground contact of the wheels of one track. In this context, the rolling movement and/or the tilting movement can occur about the longitudinal axis of the vehicle and/or about an axis which is oriented in the longitudinal direction of the vehicle.

According to a further preferred development, when weighted switching over from the first vehicle model to the second vehicle model occurs, the second vehicle model is initialized with parameters of the state of the first vehicle model. According to a further preferred development, the weighting for the weighted switching over is carried out as a function of an estimated angle, preferably of a rolling angle or tilting angle of the vehicle. It is particularly advantageous if the weighting during the switching over occurs with a rise in the weighting of the second vehicle model which is linear for increasing values of the estimated angle (φ), with a simultaneous linear drop in the weighting of the first vehicle model.

According to a further preferred development, the switching over is carried out when the angle lies between a first predetermined angle value and a second predetermined angle value, the first predetermined angle value preferably describing a vehicle angle at which a first, nonloaded wheel of a track lifts off, and the second predetermined angle value describes the vehicle angle at which a second, nonloaded wheel of the same track loses ground contact.

According to a further preferred development, when the first state is estimated as an interference variable, a longitudinal inclination of the carriageway, a transverse inclination of the carriageway, a transverse inclination rate of the carriageway and/or a coefficient of friction of the carriageway are simulated and also taken into account, the longitudinal inclination of the carriageway being preferably taken into account in conjunction with a sensed longitudinal acceleration of the vehicle.

According to a further preferred development, the longitudinal inclination of the vehicle and the transverse inclination rate of the carriageway are simulated by means of a Markov process. The coefficient of friction of the carriageway is advantageously modeled as a quasi-constant variable.

According to a further preferred development, when tilting of the vehicle is detected as a movement state, individual wheel brakes of the vehicle are selectively activated in order to stabilize the vehicle.

According to a further preferred development, the vehicle mass, the position of the center of gravity of the vehicle, the wheelbase, the track width and/or the rolling characteristic, in particular the rolling rigidity, and/or the damping of the vehicle are taken into account in the modeling of the vehicle.

According to a further preferred development, by means of brake pressures which are made available per wheel by means of the vehicle as well as by means of wheel circumferential speeds which are made available, circumferential forces of individual wheels are estimated, preferably by means of a deterministic Luenberger observer system, from which a vehicle longitudinal acceleration is estimated.

According to a further preferred development, a yaw acceleration measuring device, a transverse acceleration measuring device and preferably a longitudinal acceleration measuring device and/or a rolling rate measuring device are provided for making available the predetermined parameters.

The invention will be explained in more detail below with reference to the exemplary embodiment specified in the schematic figures of the drawing, in which:

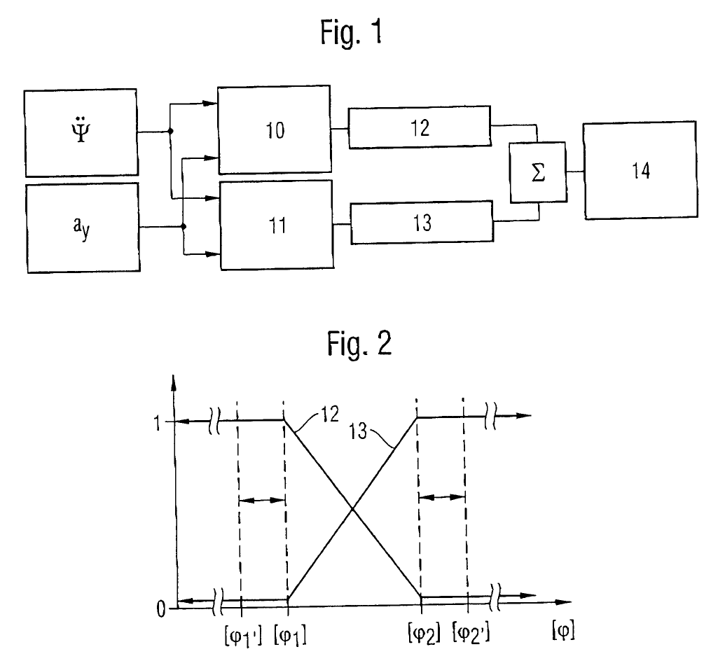

FIG. 1 is a schematic block diagram explaining the method of functioning of an embodiments of the present invention;

FIG. 2 is a schematic weighting diagram explaining the method of functioning of an embodiment of the present invention;

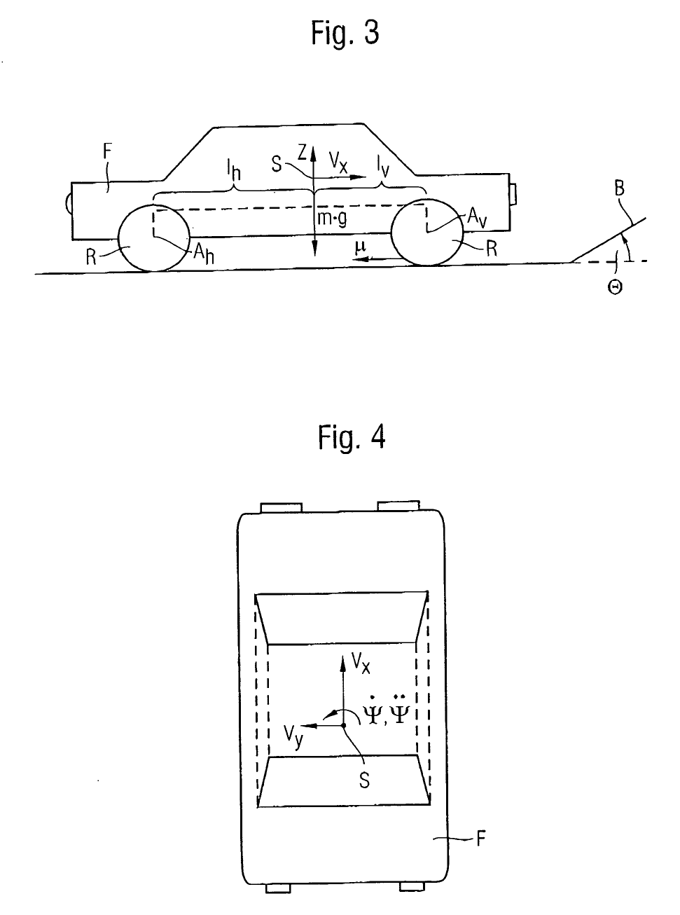

FIG. 3 is a schematic side view of a motor vehicle;

FIG. 4 is a schematic plan view of a motor vehicle; and

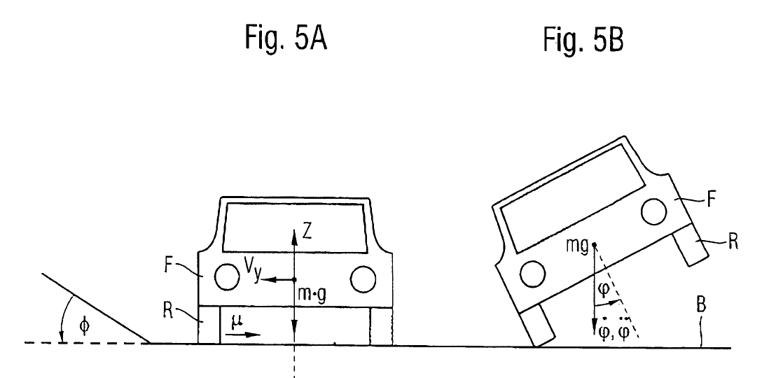

FIG. 5 is a schematic rear view of a motor vehicle, each explaining an embodiment of the present invention.

In the figures in the drawing, identical or functionally identical elements and features—unless stated otherwise—have been provided with the same reference numbers.

FIG. 1 is a schematic block diagram of a method sequence for determining a vehicle state, explaining a preferred embodiment. A transverse acceleration ay which is preferably measured by an acceleration sensor in the transverse direction of a vehicle, that is to say in the y direction, is fed to a first estimation device 10 and a second estimation device 11. Likewise, an averaged yaw acceleration \ddot{Ψ} is also fed to a first and second estimation device 10, 11. Separate state estimations are respectively carried out in the estimation device 10, 11 using a first vehicle model in the first estimation device 10 and a second vehicle model in the second estimation device 11. For the modeling of a vehicle, different Kalman filters are preferably used in the first and the second estimation devices 10, 11. Both the mass m of the vehicle F and the position of the center of gravity S in the vehicle F, the wheelbase of the vehicle, the track width at the front and rear and the rolling characteristic, that is to say in particular the rolling rigidity and damping of the vehicle with respect to a rolling movement are included in the modelings of the vehicle by means of the preferably individual Kalman filters. The first vehicle model estimates the state by means of a rolling observer.

In the second vehicle model, a tilting observer is used to estimate the vehicle state in the second estimation device 11. After this, a weighting process 12 of the state estimated by the rolling observer takes place, and a weighting process 13, separate therefrom, of the state estimated by the tilting observer. The two correspondingly weighted movement state estimations are then added in an adding device Σ, and in this way a combined state estimation 13 is available which corresponds to that of a combined observer. The weighting 12 of the rolling observer and the weighting 13 of the tilting observer 13 during the estimation of state are shown by way of example in FIG. 2.

FIG. 2 is a schematic illustration of a weighting diagram over the rolling angle or tilting angle |φ| estimated in the estimation devices 10, 11. The ordinate has a factor between 0 and 1 of the weighting factor for multiplication by the corresponding state estimation of the rolling observer or tilting observer, that is to say of the first vehicle model or of the second vehicle model. According to FIG. 2, the weighting 12 of the rolling observer with the factor 1 extends to the angle value |φ₁|, and then drops linearly between the angle value |φ₁| and the angle value |φ₂| as far as 0. Correspondingly, the weighting 13 of the tilting observer rises from the value 0 at the angle value |φ₁|, linearly to the value 1 at the angle |φ₂|. Both weighting functions 12, 13 according to FIG. 2 can be run through both in the rising direction |φ| and in the direction of smaller values for |φ|. The angle values |φ₁′| and |φ₂′| stand for alternative angle values from which a less steep rise or drop in the weighting functions 12, 13 results. Thus, a different predetermined angle value |φ₁′|, |φ₂′| is possibly to be selected when there is a rolling or tilting movement over the left hand wheels, i.e. over the left hand track, than when there is a corresponding movement over the right hand wheels, i.e. over the right hand track, of the vehicle. The angle |φ| is a rolling angle or tilting angle which is estimated by the observer systems, |φ₁| standing for an angle value at which a wheel of a track loses ground contact, and |φ₂| standing for an angle value at which both wheels of a track no longer have ground contact.

In order to stabilize a tilting movement of vehicles F with a high center of gravity it is possible, by means of selective braking interventions at individual wheels R of such a vehicle F, such as for example a truck or a transporter, to prevent a rollover of these vehicles within predetermined physical limits. In order to be able to effectively operate such a controller concept it is necessary for this system to make available various vehicle states for analysis. However, such states can be sensed or measured directly by existing sensors only to a certain extent. For this reason it is appropriate to estimate the states of the vehicle which are required beyond this by means of an observer method. A basic equation for various observer methods is:
\dot{\hat{x}}=\hat{f}(\hat{x}, u)+(\hat{x}, u)·(y−ŷ)ŷ=ĥ(\hat{x}, u) (1)

The difference between different observer methods is the calculation of the feedback matrix K(x, u), in which case, according to the present preferred embodiment, a Kalman filter is used which takes into account the stochastic properties of the system for the calculation of the feedback matrix K(x, u). The various Kalman filters differ here in the model equations \hat{f}(\hat{x}, u) and ĥ(\hat{x}, u) so that in each case different feedback values are obtained. In order to stabilize a vehicle when a tilting angle φ occurs, generally knowledge of the following vehicle states is assumed: velocity in the longitudinal direction vₓ of the vehicle, velocity in the transverse direction v_{y} of the vehicle, the rolling angle or tilting angle φ, and the rolling rate or tilting rate \dot{φ}. Rolling movement is understood here to be a rotational movement about the longitudinal axis of a vehicle, that is to say the x axis, which arises as a result of spring compression of a vehicle F on one track side. During a rolling movement, all the wheels R have ground contact. If a track of the vehicle is lifted off from the ground, i.e. before the wheels of one side of the vehicle are lifted off form the ground, the rotational movement about the longitudinal axis of the vehicle is referred to below as a tilting movement or tilting. At this point it is to be noted that the rolling movement and/or the tilting movement can take place not only about the longitudinal axis of the vehicle or x axis, but also about an axis which is oriented in the longitudinal direction of the vehicle.

According to one preferred embodiment, in order to be able to observe the abovementioned, necessary vehicle states over the entire rolling movement and tilting movement of a vehicle two different Kalman filters are used for modeling the vehicle. In this context, the first Kalman filter assumes the role of estimating the driving state during the rolling movement, while the second Kalman filter estimates the states during the tilting movement for the modeling of the vehicle. Furthermore, basically, it is also possible to estimate the required vehicle states with an individual Kalman filter while a suitable model is used. The basis for the filter device which is used for estimating the rolling movement is formed by the following movement equations of the horizontal velocities:
\dot{v}_{y}=−\dot{Ψ}vₓ+a_{y}\dot{v}ₓ=\dot{Ψ}v_{y}+aₓ (2)

A change \dot{v}_{y} in velocity in the y direction thus corresponds to the negative product of a yaw rate \dot{Ψ} and a longitudinal velocity v_{y} of the vehicle in addition to an acceleration a_{y} in the y direction. Furthermore, a change \dot{v}ₓ in velocity in the x direction equals the product of the yaw rate \dot{Ψ} and of the velocity v_{y} of the vehicle in the transverse direction plus an acceleration aₓ in the longitudinal direction. If the horizontal accelerations a_{y}, aₓ which are measured by means of sensors are used within these two equations as input signals, the following linearized system equations for the rolling filter are obtained after transformation from a coordinate system or reference system which is fixed to the vehicle into one which is fixed to the carriageway:
\dot{v}ₓ=\dot{Ψ}v_{y}+g(θ+Θ)+aₓ^{sensor}\dot{v}ᵥ=−\dot{Ψ}vₓ−g(φ+Φ)+a_{y}^{sensor} (3)

Compared to the equation system (2), the product of the acceleration g of the earth and the sum of a vehicle pitching angle θ and a carriageway inclination Θ are added for the term in the longitudinal direction of the vehicle. In the movement equation in the y direction, a subtractive additional term is obtained as a product of the acceleration g of the earth and the sum of the rolling angle φ measured over the carriageway plus the transverse inclination Φ of the carriageway. A differential equation of the rolling dynamics serves as a further basic equation and applies for small rolling angles and results from the law of conservation of angular momentum about the longitudinal axis of the vehicle:

$$\ddot{φ} = \frac{{}_{Δ}^{}{h}{}_{s}^{} ( {F}_{Sv} + {F}_{Sh} + m ( {a}_{z} + g ) φ ) + {M}_{W}}{{J}_{XX}} \qquad ( 4 )$$

\ddot{φ} for the rolling angle acceleration, _{Δ}hₛ for a shift in the center of gravity, Fₛᵥ for the front side force of the wheels, Fₛₕ for the side force of the wheels R of the rear axle Aₕ, m for the mass of the vehicle, a_{z} for the acceleration in the Z direction, which corresponds to the vertical axis in the vehicle F, M_{w} corresponding to a rolling movement and J_{XX} corresponding to a moment of inertia about the longitudinal axis of the vehicle. If the rolling moment M_{w} is included in this equation as:
M_{w}=−c_{φ}·φ−d_{φ}·\dot{φ} (5)

where c_{φ}and d₁₀₀ represent predetermined variables which are constant or possibly also dependent on the rolling angle or tilting angle, the side forces of the wheels F_{SV}, Fₛₕ as a result of the transverse acceleration are expressed correspondingly:
Fₛᵥ+Fₛₕ=m(a_{y}+gΦ) (6)

The linearized system equation for the rolling dynamics within the vehicle model, preferably within the Kalman filter, is thus obtained as:

$$\ddot{φ} = - \frac{{c}_{φ}}{{J}_{XX}} φ - \frac{{d}_{φ}}{{J}_{XX}} \dot{φ} + \frac{{}_{Δ}^{}{h}{}_{s}^{} m}{{J}_{XX}} {a}_{y}^{sensor} + {w}_{φ} ( t ) \qquad ( 7 )$$

where the term w_{\dot{φ}} (t) stands for an interference variable term which is dependent on the time, corresponding to stochastic noise. Furthermore, the longitudinal inclination Θ of the carriageway, the transverse inclination Φ of the carriageway, the transverse inclination rate \dot{Φ} of the carriageway and the coefficient of friction μ of the carriageway are modeled as interference variables. The longitudinal inclination Θ of the carriageway and the transverse inclination rate \dot{Φ} of the carriageway are preferably simulated here by means of a Markov process corresponding to colored noise which can be attributed to white noise since these two variables are stochastic, correlated variables. The coefficient of friction μ of the carriageway is modeled in particular as a quasi-constant variable.

The directions or angles of the different variables are illustrated schematically using FIGS. 3, 4, 5a and 5b. A velocity vₓ of the vehicle in the longitudinal direction of the vehicle is illustrated in FIG. 3, said velocity vₓ acting by way of example at the center of gravity S of the vehicle at which the force of gravity m·g acts radially with respect to the center of the earth. The movement of the vehicle in the vₓ direction is counteracted by a frictional force of the tires which is illustrated by way of example by means of the coefficient of friction μ of the carriageway. A possible longitudinal inclination of the carriageway via the inclination angle Θ is also apparent from the schematic side view according to FIG. 3. In turn, the velocity vₓ of the vehicle in the longitudinal direction of the vehicle and a velocity v_{y} in the transverse direction of the vehicle are illustrated in the schematic plan view according to FIG. 4. Furthermore, a yaw rate \dot{Ψ} acting at the center of gravity S and a yaw acceleration \ddot{Ψ} are illustrated by way of example. FIGS. 5a and 5b illustrate the vehicle inclination angle φ and the inclination angle rate \dot{φ} and inclination angle acceleration \ddot{φ} as well as once more the transverse acceleration v_{y} of the vehicle with a correspondingly illustrated frictional force in the opposite direction, which acts on the vehicle wheels R as a function of the coefficient of friction μ of the carriageway. The vehicle F is orientated in the horizontal direction on the carriageway B according to FIG. 5a, and the carriageway B can also have a transverse inclination angle Φ of the carriageway here.

The measuring equations of the vehicle model or Kalman filter responsible for the rolling movement are obtained by applying the law of momentum and the law of conservation of angular momentum and are as follows:
a_{y}^{sensor}=(Fₛᵥ+Fₛₕ)/m+gφ+vₐ_{_{y}}aₓ^{sensor}=(F_{Uv}+F_{Uh})/m−gθ+vₐ_{ₓ}\ddot{Ψ}^{sensor}=(lᵥF_{Sv}−lₕF_{Sh}+M_{B})/J_{ZZ}+V₁₀₅ (8)

vₐ_{_{y}}, vₐ_{ₓ} and v_{\ddot{Ψ}} corresponding to measuring noise of the corresponding variables a a_{y}^{sensor}, aₓ^{sensor} and \ddot{Ψ}^{sensor} which are measured by means of a sensor. A circumferential force F_{Uv} and F_{Uh} of the tire in the longitudinal direction of the vehicle, that is to say in the x direction, corresponds to the side forces F_{Sv} and F_{Sh} of the tires in the transverse direction, that is to say in the y direction. The side forces F_{Sv} and F_{Sh} are included, each multiplied by the distance lᵥ and lₕ between the center of gravity S and the front vehicle axle Aᵥ and the rear vehicle axle Aₕ according to FIG. 3, in the yaw acceleration \ddot{Ψ}^{sensor}. The torque M_{B} corresponds to a torque which acts on the circumferential forces F_{Uv,h} with the radius at the center of gravity S. J_{ZZ} signifies a moment of inertia in the z direction, that is to say about the vertical axis of the vehicle F. The yaw acceleration \ddot{Ψ}^{sensor} can be determined here from the yaw rate \dot{Ψ}, for example by means of a DT₁ filter.

If the vehicle F changes from the rolling movement into the tilting movement according to FIG. 5b, the estimation of the states according to FIGS. 1 and 2 is transferred to the second vehicle model, in particular the second Kalman filter. In order to shorten the transient recovery phase of this second filter, it is initialized with the states, estimated until now, for the filter which is responsible for the rolling movement. The transition from the estimations of the first filter which is responsible for the rolling movement to the estimations of the second filter which is responsible for the tilting movement is carried out by means of a weighted filter switchover according to FIG. 2. Within this switchover process, the states which are estimated by both vehicle models or Kalman filters are weighted as a function of the rolling angle or tilting angle |φ| and then added in the addition device Σ according to FIG. 1. The weighting function according to FIG. 2 is as follows here:

$$\begin{matrix}{\hat{x}}_{gB} = {\hat{x}}_{roll} ( 1 - ɛ ) + {\hat{x}}_{tilt} \cdot ɛ & ( 9 ) \\ with \text{:} \\ ɛ = \{ \begin{matrix}0 , & \vert φ \vert < \vert {φ}_{1} \vert \\ \frac{( φ - {φ}_{1} )}{( {φ}_{2} - {φ}_{1} )} , & \vert {φ}_{1} \vert \leq \vert φ \vert \leq \vert {φ}_{2} \vert . \\ 1 , & \vert φ \vert > \vert {φ}_{2} \vert\end{matrix} & ( 9 )\end{matrix}$$

Here, the two angles φ₁, φ₂ define the region in which the weighted switchover process is completed (see FIG. 2). φ₁ is the angle of the vehicle F at which the first wheel R of the nonloaded track lifts off, and the angle φ₂ designates the angle at which the second wheel R of this track also loses contact with the ground.

Within this range between φ₁ and φ₂ there is no uniquely defined assignment, whereas outside this range there is a uniquely defined assignment to one of the two vehicle models, preferably the Kalman filter. This uniform gradual transition of the states from one vehicle model or filter to the other allows a continuous transition of the state estimation without jumps.

The basis for this system equation of the vehicle model which is responsible for the tilting movement, preferably the Kalman filter, is also formed by the law of momentum and the law of conservation of angular momentum. It is notable here that, in contrast to the vehicle model or filter which is responsible for the rolling movement, the system equation differs over the left hand side and right hand side of the vehicle F for the tilting movement. Also, within the system equation of the second vehicle model or filter which is responsible for the tilting movement, nonlinear tire forces are replaced to a great extent by values of acceleration sensors. Written in a generalized form, the system equations of this second Kalman filter are as follows:

$${a}_{y} = {\dot{v}}_{x} = \frac{ⅆ {v}_{x}}{ⅆ t} = - \frac{1}{cos φ} \{ {\dot{Ψ}}_{sensor} {v}_{x} - \frac{1}{ξ ( φ )} ξ ( {a}_{y}^{sensor} , φ , \dot{φ} , {\dot{ψ}}_{sensor} ) \} + {w}_{xy} \\ {a}_{x} = {\dot{v}}_{x} = \frac{ⅆ {v}_{x}}{ⅆ t} = \frac{{\dot{Ψ}}_{sensor} \cdot {v}_{y}}{cos φ} + {a}_{x}^{corr} + g Θ + {w}_{xy} \\ \ddot{φ} = \frac{ⅆ \dot{φ}}{ⅆ t} = \frac{1}{ϑ ( φ )} \cdot λ ( φ , \dot{φ} , {a}_{y}^{sensor} , {\dot{ψ}}_{sensor} ) + {w}_{\dot{φ}} \qquad ( 10 )$$

the terms W_{vy}, Wᵥₓ and W_{\dot{φ}} representing a noise component of the corresponding states and ξ, [symbol] , λ representing actual variables. The system equations of the individual interference variables W_{vy}, Wᵥₓ, W_{\dot{φ}} correspond to those of the vehicle model or Kalman filter which are responsible for the rolling movement. The transverse inclination Φ of the carriageway and transverse inclination rate Φ of the carriageway can however not be estimated with this filter since when a vehicle F tilts there is no difference between the effects of the transverse inclination of the carriageway and the tilting angle. These two interference variables therefore cannot be observed. The nonlinearities which originate from the characteristic curves of the tires are also input into the measuring equation within this filter. The generalized measuring equations of the second filter which is responsible for the tilting movement are obtained as follows from the law of momentum and the law of the conservation of angular momentum:

$${a}_{x}^{sensor} = \frac{{\sum }_{i = 1}^{n} {F}_{Ry , i}}{m ( 1 + {θ}_{0} )} + {v}_{a} \\ {a}_{y}^{sensor} = \frac{{\sum }_{i = 1}^{n} {F}_{Ry , i} \cdot cos φ}{m} + \frac{sin φ}{η ( φ )} σ ( φ , {\dot{Ψ}}_{sensor} , {F}_{Ry , i} , \dot{φ} ) + {v}_{{a}_{i}} \\ {\ddot{Ψ}}_{sensor} = \frac{cos φ}{{J}_{yi} {sin}^{2} φ + {J}_{zz} {cos}^{2} φ} ɛ ( φ , {\dot{Ψ}}_{sensor} , \dot{φ} , {F}_{Rx , i} , {F}_{Ry , i} , {M}_{Rz , i} ) + {v}_{φ} \\ {\dot{φ}}_{sensor} = \dot{φ} + {v}_{φ} \qquad ( 11 )$$

θ₀ representing a static pitch angle component and the term

$$\frac{sin φ}{η ( φ )} σ$$

representing a portion of the acceleration of the earth while M_{RZ,i} represents a restoring moment. All the variables are converted here to a horizontal coordinate system, from which the sin φ, cos φ components follow. Instead of using the yaw acceleration \ddot{Ψ}ₛₑₙₛₒᵣ as measuring variable it is possible to define the yaw rate \dot{Ψ} either as a state variable or as a measurement variable. As a result, even though the filter equations of the rolling observer, that is to say of the first vehicle model or Kalman filter, are not linear, it is nevertheless possible to take into account the sensor property, in particular the measuring noise, in the filter more precisely.

By using the braking pressures per wheel made available by an ESP system (electronic stability program) which is preferably present, and by using the knowledge of the rotational speeds of the individual wheels R it is possible to estimate the circumferential forces F_{Uh,v} of the individual wheels R of the vehicle F. This is preferably done by means of a deterministic Luenberger observer. Its estimated circumferential forces F_{U} can be used, according to the principle, within the two vehicle models or Kalman filters to replace the longitudinal acceleration sensor for measuring the acceleration in the x direction, that is to say aₓ^{sensor}. Furthermore, by using the estimated circumferential forces Fᵤ it is possible to introduce four additional measuring equations within the Kalman filters. Furthermore, the normal forces of the individual wheels R of the vehicle F are calculated by means of a static model or by means of a dynamic model. These calculated normal forces are required for the tire model which is used within the two Kalman filters.

By means of the present invention it is thus possible to determine a movement state, in particular rolling or tilting of a vehicle, using acceleration information of an acceleration in the y direction a_{y}, a yaw acceleration \ddot{Ψ} and, if appropriate, an acceleration value in the x direction aₓ, the vehicle state, in particular the rolling angle or tilting angle φ. Furthermore, when modeling a truck in which considerable shifting of the center of gravity occurs as a result of the cargo, the rolling rate \dot{φ} is necessary to simulate the vehicle states.

Although the present invention has been described above with reference to preferred exemplary embodiments, it is not restricted thereto but rather can be modified in a variety of ways. A different weighting from the linear weighting of the corresponding vehicle models which is illustrated in FIG. 2 at the transition is thus also basically conceivable. Theoretically, the modeling of the vehicle can also be made available by means of a single Kalman filter whose parameter is adapted in accordance with the modeling of the vehicle.

To conclude, the following is to be noted: the following terms used in the statements above “vehicle state”, “state of a vehicle”, “vehicle movement state” and “movement state” are all used synonymously. If, for example, the determination of a vehicle state is mentioned, in accordance with the exemplary embodiments above the determination of a rolling angle or tilting angle as a vehicle movement variable is meant.

1. A method for determining a vehicle state having the method steps:
estimation of a first state in a vehicle (F) by means of a first vehicle model using predetermined parameters (\dot{Ψ}, \ddot{Ψ}, a_{y}, aₓ);
estimation of a second state of the vehicle (F) by means of a second vehicle model using the predetermined parameters (\dot{Ψ}, \ddot{Ψ}, a_{y}, aₓ)
characterized in that
a weighting process (12) of the first state of the vehicle (F) and a weighting process (13) of the second state of the vehicle (F) which is separate therefrom are each carried out as a function of at least an estimated parameter (φ), gradual transition from one vehicle model onto the other vehicle model by superimposing (Σ) the weighted first state and the weighted second state taking place.

2. The method as claimed in claim 1, characterized in that the first vehicle model simulates movement states of the vehicle (F) by means of a first Kalman filter, and the second vehicle model simulates movement states of the vehicle (F) by means of a second Kalman filter.

3. The method as claimed in claim 1, characterized in that the first state of the vehicle stands for a rolling movement of the vehicle (F), and the second state of the vehicle stands for a tilting movement of the vehicle (F), a rolling movement describing a rotational movement about a vehicle longitudinal axis with ground contact with all the wheels, and a tilting movement corresponding to a rotational movement which follows the rolling movement with loss of the ground contact of at least the wheels (R) of one track.

4. The method as claimed in claim 1, characterized in that, when gradual transition from the first vehicle model to the second vehicle model occurs, the second vehicle model is initialized with parameters (\dot{Ψ}, \ddot{Ψ}, a_{y}, aₓ) of the state of the first vehicle model.

5. The method as claimed in claim 1, characterized in that the weighting for the gradual transition is carried out as a function of an estimated angle (φ), preferably of a rolling angle or tilting angle of the vehicle (F), in particular with a rise in the weighting (13) of the second vehicle model which is linear for increasing values of the estimated angle (φ), with a simultaneous linear drop in the weighting (12) of the first vehicle model.

6. The method as claimed in claim 5, characterized in that the gradual transition is carried out when the angle (φ) lies between a first predetermined angle value (φ₁) and a second predetermined angle value (φ₂), the first predetermined angle value (φ₁) preferably describing a vehicle angle at which a first, nonloaded wheel (R) of a track lifts off, and the second predetermined angle value (φ₂) describes the vehicle angle at which a second, nonloaded wheel (R) of the same track loses ground contact.

7. The method as claimed in claim 1, characterized in that, when the first state is estimated as an interference variable, a longitudinal inclination (Θ) of the carriageway, a transverse inclination (Φ) of the carriageway, a transverse inclination rate (\dot{Φ}) of the carriageway and/or a coefficient of friction (μ) of the carriageway are simulated and taken into account.

8. The method as claimed in claim 7, characterized in that the longitudinal inclination (θ) of the carriageway and the transverse inclination rate (\dot{Φ}) of the carriageway are simulated by means of a Markov process, and the coefficient of friction (μ) of the carriageway is modeled as a quasi-constant variable.

9. The method as claimed in claim 1, characterized in that, when tilting of the vehicle (F) is detected as a movement state, individual wheel brakes of the vehicle (F) are selectively activated in order to stabilize the vehicle (F).

10. The method as claimed in claim 1, characterized in that the vehicle mass (m), the position of the center of gravity (S) of the vehicle, the wheelbase, the track width and/or the rolling characteristic, in particular the rolling rigidity, and/or the damping of the vehicle are taken into account in the modeling of the vehicle.

11. The method as claimed in claim 1, characterized in that, by means of brake pressures which are made available per wheel (R) by means of the vehicle (F) as well as by means of wheel circumferential speeds which are made available, circumferential forces of individual wheels (R) are estimated, preferably by means of a deterministic Luenberger observer system, from which a vehicle longitudinal acceleration (aₓ) is estimated.

12. A device for determining a vehicle state, in particular for operating a method as claimed in one of the preceding claims, having:
a first estimation device for estimating a first state of a vehicle (F) by means of a first vehicle model using predetermined parameters (\dot{Ψ},\ddot{Ψ}, a_{y}, aₓ),
a second estimation device for estimating a second state of the vehicle (F) by means of a second vehicle model using the predetermined parameters (\dot{Ψ},\ddot{Ψ}, a_{y}, aₓ),
characterized in that
a weighting process (12) of the first state of the vehicle (F) and a weighting process (13) of the second state of the vehicle (F) which is separate therefrom are each carried out as a function of at least an estimated parameter (φ), gradual transition from one vehicle model onto the other by superimposing (Σ) the weighted first state and the weighted second state taking place.

13. The device as claimed in claim 12, characterized in that a yaw acceleration measuring device, a
transverse acceleration measuring device and preferably a longitudinal acceleration measuring device and/or a
rolling rate measuring device are provided for making available the predetermined parameters.
